(19) United States
(12) Patent Application Publication
(10) Pub. No.: US 2007/0239471 A1
(43) Pub. Date: Oct. 11, 2007

(54) Systems and methods for specifying security for business objects using a domain specific language

(76) Inventors: Richard D. Patton, Hastings, MN (US); Vinod Mathur, Rosemount, MN (US); Barbie Sue Sokol, Cottage Grove, MN (US); Damien Bouard, Torcy (FR)

Correspondence Address: SCHWEGMAN, LUNDBERG & WOESSNER, P.A., P.O. BOX 2938, MINNEAPOLIS, MN, 55402, US

(21) Appl. No.: 11/400,752

(22) Filed: Apr. 7, 2006

(51) Int. Cl. G06Q 10/00; G06F 9/44; G06Q 30/00

(52) U.S. Cl. 705/1; 705/7

(57) ABSTRACT

Systems and methods generate code implementing security rules using a description of a business ontology and a pattern language describing access rules for business objects in the business ontology.

### FIELD

The embodiments of the present invention relate to providing a security specification. More specifically, the embodiments relate to a domain specific language for providing security specifications.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright© 2006 Lawson Software, Inc.

### BACKGROUND

Business software applications play an important role in running almost every business in operation today. Applications such as general ledger, time and accounting, human resources and other applications enable business to run efficiently and comply with regulatory requirements.

Developing and modifying business software applications typically requires the involvement of many people. For example, business analysts may be required in order to specify the functionality required by the application. Once the functionality has been identified, teams of software developers may then be needed to create the software making up the application.

Access security is an important aspect of business software applications. Different users must typically be granted differing levels of access to different functions of a business application. For example, one user may be allowed to view, but not change data in one portion of an application, while another user may be allowed to create and update data across all functions of the application. Specifying the security requirements and then implementing the security requirements can be a time consuming and laborious process.

### BRIEF DESCRIPTION OF THE DRAWINGS

FIG. 1A is a diagram illustrating the major components of a design time system according to embodiments of the invention.

FIG. 1B is a diagram illustrating major runtime components of a system according to embodiments of the invention.

FIG. 2A is a diagram illustrating an example security privileges hierarchy according to embodiments of the invention.

FIG. 2B is a diagram illustrating an example securable object hierarchy according to embodiments of the invention.

FIG. 3 is a flowchart illustrating an exemplary method for generating a security interface according to embodiments of the invention.

FIG. 4 is a flowchart illustrating a method for evaluating security authorization according to embodiments of the invention.

FIGS. 5A and 5B are flowcharts illustrating methods for predicting a security evaluation according to embodiments of the invention.

FIG. 6 is a flowchart illustrating a method for displaying object data in accordance with a security evaluation according to embodiments of the invention.

FIG. 7 is an example screen display according to the method illustrated in FIG. 6.

FIGS. 8A and 8B are example pattern language segments illustrating example definitions of business classes.

FIGS. 9A and 9B are example pattern language segments illustrating key field definitions for the business classes illustrated in FIGS. 8A and 8B

FIGS. 10A-10D are example security pattern language segments illustrating example definitions of security classes associated with the example business classes illustrated in FIGS. 8A and 8B.

### DETAILED DESCRIPTION

In the following detailed description, reference is made to the accompanying drawings that form a part hereof, and in which is shown by way of illustration, specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

In the Figures, the same reference number is used throughout to refer to an identical component which appears in multiple Figures. Signals and connections may be referred to by the same reference number or label, and the actual meaning will be clear from its use in the context of the description.

The functions or algorithms described herein are implemented in hardware, and/or software in embodiments. The software comprises computer executable instructions stored on computer readable media such as memory or other types of storage devices. The term “computer readable media” is also used to represent software-transmitted carrier waves. Further, such functions correspond to modules, which are software, hardware, firmware, or any combination thereof. Multiple functions are performed in one or more modules as desired, and the embodiments described are merely examples. A digital signal processor, ASIC, microprocessor, or any other type of processor operating on a system, such as a personal computer, server, a router, or any other device capable of processing data including network interconnection devices executes the software.

Some embodiments implement the functions in two or more specific interconnected hardware modules or devices with related control and data signals communicated between and through the modules, or as portions of an application-specific integrated circuit. Thus, the example process flow is applicable to software, firmware, and hardware implementations.

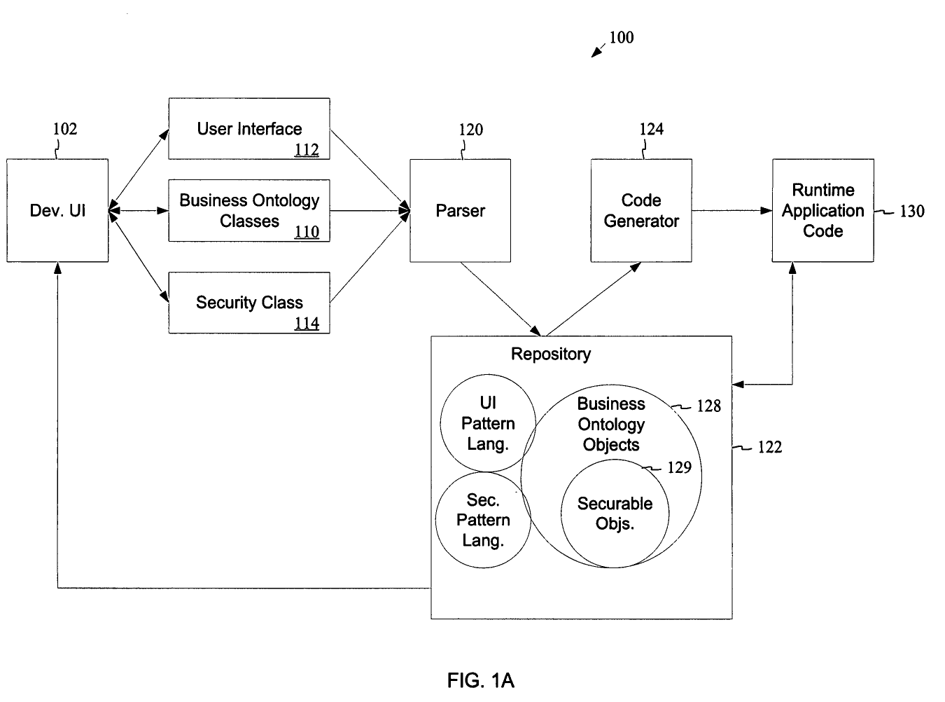

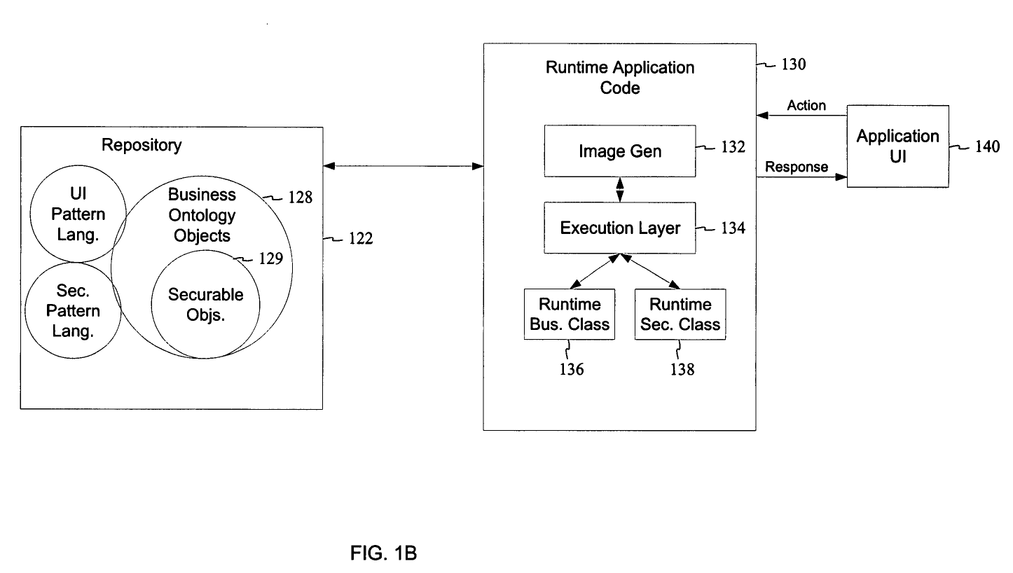

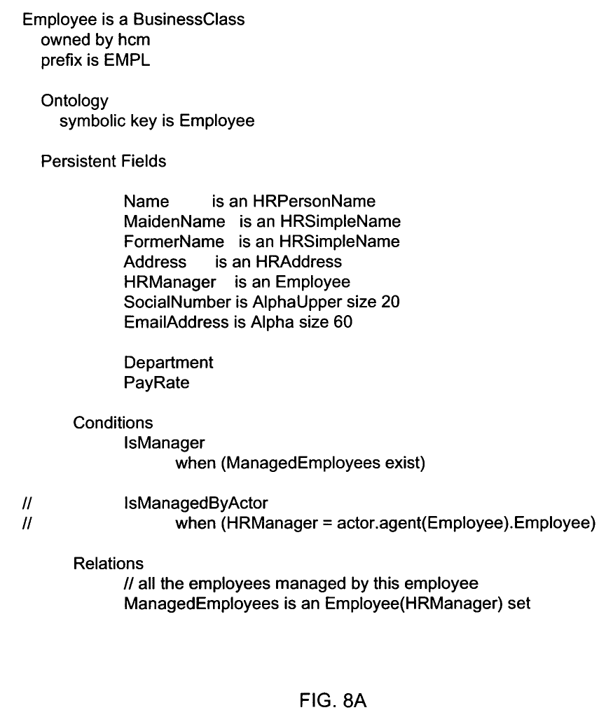

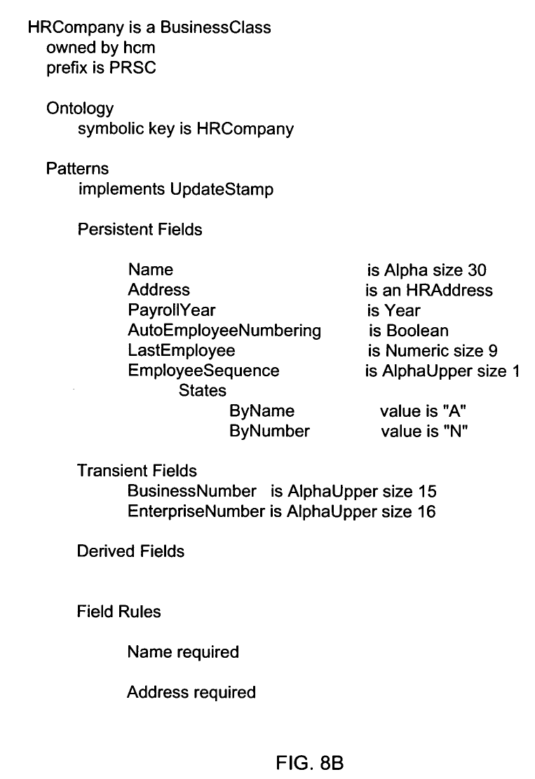

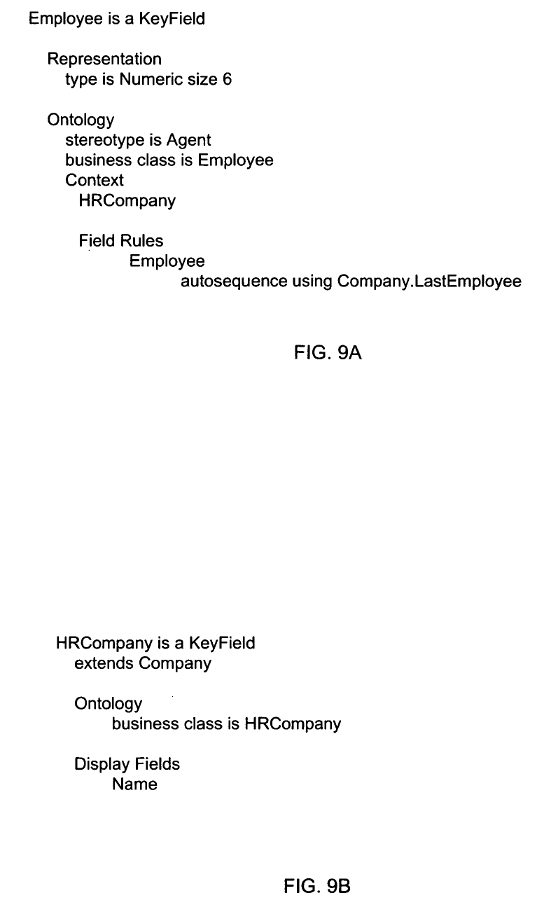

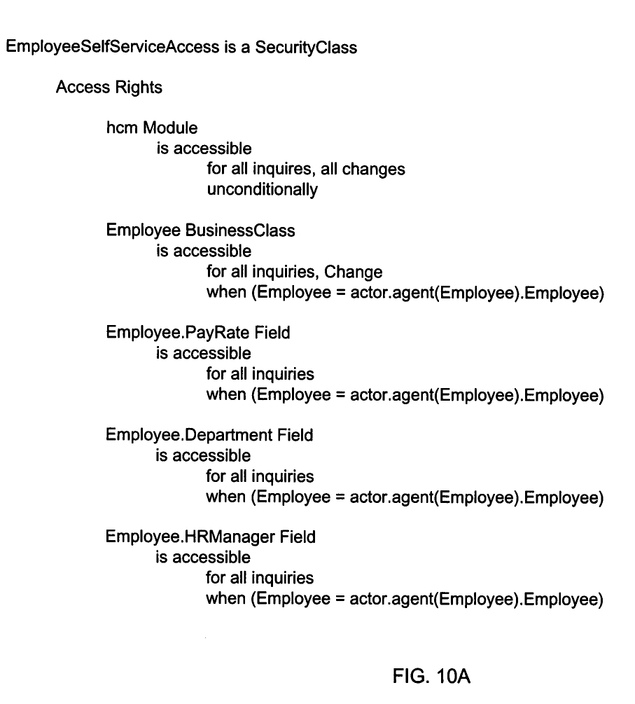

FIG. 1A is a diagram illustrating the major components of a system 100 according to embodiments of the invention. In some embodiments, system 100 includes development environment 102, parser 120, repository 122 and code generator 124. Development environment 102 may provide a graphical user interface useful in specifying a business ontology defining data and business rules to be applied to the data for a to a business application under development. In some embodiments, development environment provides an interface for specifying a business ontology using a pattern language. In particular embodiments, the pattern language is the Lawson Pattern Language (LPL) developed by Lawson Software of St. Paul, Minn. In some embodiments, development environment 102 may allow a developer to define and modify pattern language relating to business ontology classes 110, user interface 112 and security classes 114. In some embodiments, business classes 110 are classes that define business objects having fields containing data for the business object. In general, a business class is typically a user defined set of fields and rules that are related in some way. For example, a business class describing an employee may include fields that specify the employees name, title, tax identification number, address, pay rate etc. In addition, business ontology classes 110 include metadata defining relationships between business objects. For example, key fields may be defined that are used to relate elements having the same key. Also, business ontology may include an ontological context that a business object has. Ontological contexts describe the affordance structure of business objects. For example as illustrated in FIG. 9A, the key field definition for an employee is defined such that an employee always exists in the context of an “HRCompany”. Additionally, business objects may be related by their position in a business class hierarchy. The business ontology classes 110 may also include pattern language defining business rules that may be applied to the business objects and fields within the business objects. Still further, business ontology classes 110 may include metadata defining actions and tasks or processes (business tasks) that may be performed. Example business classes providing definitions using a pattern language according to embodiments of the invention are provided in FIGS. 8A-8B and 9A-9B.

In some embodiments, user interface 112 may include elements that define an application interface, a menu, and specification for how the objects and fields of a business class 110 should appear on a user interface. User interface pattern language elements may be used to define how objects in the business ontology are presented to the user. For example, the user interface pattern language elements may define aspects of a business application, and the pages, menus, panes, and columns for displaying data related to business objects used by the business application.

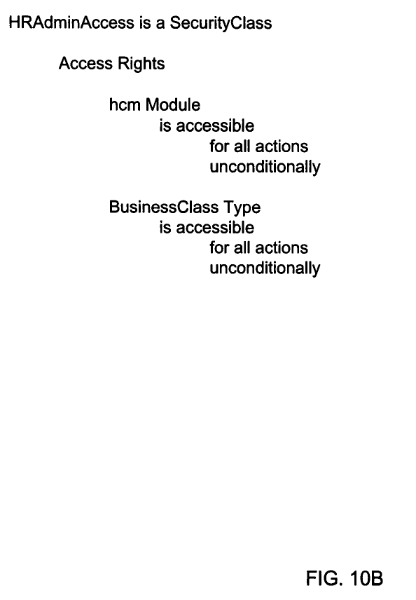

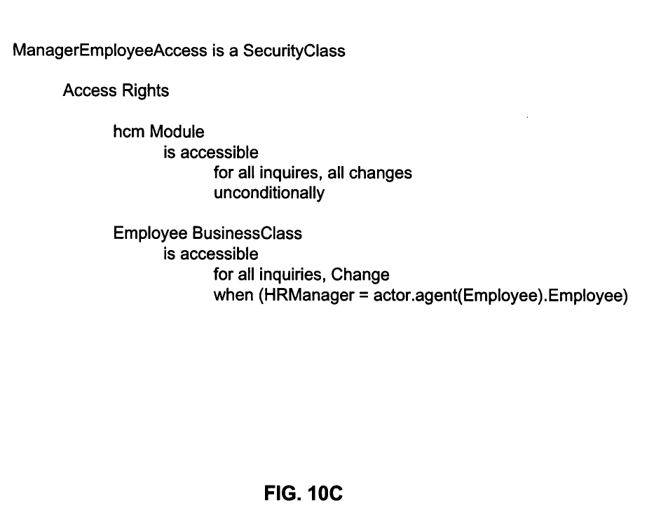

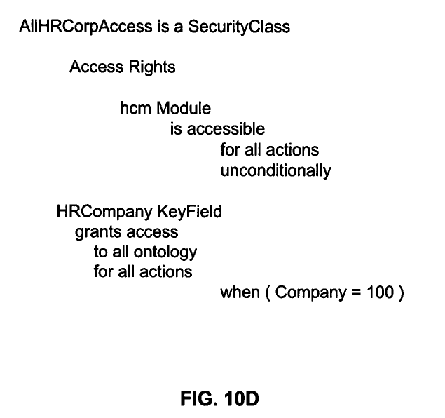

In some embodiments, security classes 114 define security, including access authorization rules for business objects defined in business ontology classes 110. Example pattern language elements providing security definitions for the business classes defined in FIGS. 8A and 8B are provided in FIGS. 10A-10D. In some embodiments, the pattern language provides grammar elements that allow an application designer to specify business objects, what actions may be performed on the business object, and the conditions under which the actions maybe performed. For example, a security class may specify that managers can update a pay rate field of an employee business class object. The security class may further specify that an employee can update address fields in the employee business class object, but can only view and not update the pay rate field. Further details on the operation of security classes will be provided below.

Parser 120 parses the pattern language defining the data and business rules into business objects 128 for storage in repository 122. In some embodiments, parser 120 reads the files described above and parses pattern language elements found in the files. The business objects 128 produced by parser 120 comprise a translation of the business rules and data into an object for that is more easily processed by a computer system. A subset of some or all of the business objects 128 are securable objects 129. In some embodiments, securable objects 129 include business class objects, key fields, fields, module objects describing a module, business task objects, and data areas. In some embodiments, a data area is an instance in a RDBMS (Relational Database Management System) of all schema related to an application. For example, there may be several named instances sharing the same application definition but each application may have its own set of tables in the RDBMS. In addition, parser 120 may parse security definitions in as security class defined using a pattern language into security metadata that is maintained in repository 122. A BNF (Bachus Naur Form) specification for a pattern language (LPL) used to define a business ontology and user interface according to some embodiments is provided in Appendix A of this specification. A BNF specification for a pattern language used to define security aspects for the business ontology according to some embodiments is provided in Appendix B of this specification. The parser 120 may follow the syntax rules defined within the LPL and security BNF specifications in order to parse pattern language elements. In some embodiments, the business objects may be parsed into Java language objects.

Repository 122 is a database designed to store the business objects produced by parser 120. Repository 122 may be any type of database. In some embodiments, repository 122 may be a relational database. However, repository 122 may be a hierarchical database, an object-oriented database, or a database comprising one or more files in a file system. In some embodiments, the repository includes a business ontology specifying the attributes and business rules for various business classes.

Code generator 124 reads repository 122 to obtain the business object definitions, the user interface pattern language elements used to define the layout for the business object data, and the security class definitions and generates runtime application code 130. Runtime application code 130 includes code that implements the data structures and methods that manipulate business objects defined by the business class, the user interface code, and the security code used to authorize access to the business objects. In some embodiments, the runtime application code 130 comprises Java code. Further details on Java may be found in the Java™ 2 Platform, Standard Edition, v 1.4.2 API Specification.

FIG. 1B is a diagram illustrating major runtime components 130 of a system according to embodiments of the invention. In some embodiments, runtime application code 130 includes image generator 132, execution layer 134, runtime business class 136 and runtime security class 138. Image generator 132 executes runtime code that is generated in accordance with the user interface specification pattern language 112. In general, the image generator 132 generates output in response to an action received from an application user interface 140. Examples of actions are create actions, inquire actions, update actions, and delete actions and specializations thereof. Create actions create new database records for one or more business objects. Inquire actions read database records for one or more business objects, but do not update or delete the records. Update actions cause an update to previously existing database records for one or more business objects. Delete actions delete database records for one or more business objects. It should be noted that specialized actions may be defined for a business class, however, specialized actions typically fall into one of the create, inquire, update, or delete actions. The runtime business class 136 includes code generated by code generator 124 that actually performs the actions received from an application user interface 140. Runtime security class 138 comprises executable code generated by code generator 124 that performs security and authorization analysis according to the rules defined by security class 114.

In general, an application that has been generated according to the pattern language defining the business ontology, security rules, and user interface operates as follows. An application user is authenticated via application user interface 140. The user issues actions (e.g. create, inquire, update or delete) actions for business objects in a database. The runtime application receives the action, and calls one or more functions in runtime security class 138 to determine if the user authorization allows access to the business objects or fields within the business objects. If access is allowed on at least some of the fields of the business object, the runtime business class functions and methods are invoked to perform the requested action. The image generator 132 then displays the resulting response to the user via the application user interface 140.

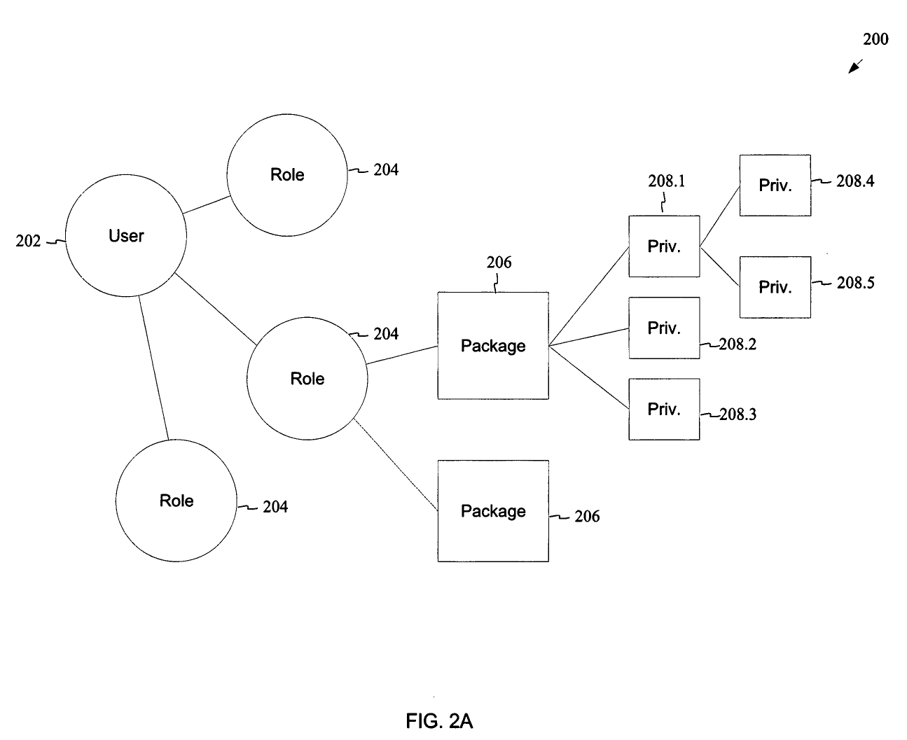

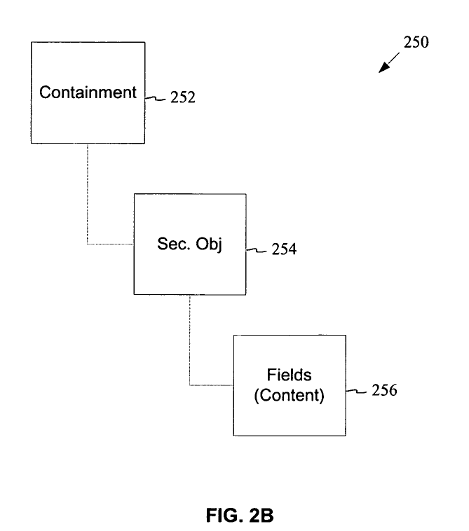

FIG. 2A is a diagram illustrating an example security privileges hierarchy 200 according to embodiments of the invention. In some embodiments, a security privileges hierarchy includes one or more users 202, one or more roles 204, one or more packages 206 and one or more privileges 208. A user 202 comprises a particular user of an application. Typically a user will be uniquely determined by a user identification and password. One or more roles 204 may be assigned to the user identification. For example, in a human resource application, a user may have an employee role, a manager role, an officer role, and/or an administrator role. Each of these roles 204 may have one or more packages 206 defining the business objects that a user having the role may access, and the type of access that is granted for the role (e.g. create, inquire, update, delete). A package 206 is a collection of privileges 208 included in the package 206. A privilege 208 is a particular privilege regarding a business object or a field within a business object. A user may have more than one role (e.g. employee and manager). An individual package 206 may be included in more than one role 204. An individual privilege may be included in more than one package. Additionally, a privilege may include other privileges 208. For example, privilege 208.1 includes privileges 208.4 and 208.5.

In some embodiments, users and roles are defined in a repository or database, while packages and privileges are defined using a pattern language that defines one or more security classes 114. However, the embodiments are not limited to any particular distribution of user, roles, packages and privileges between database/repository definitions and pattern language definitions.

FIG. 2B is a diagram illustrating an example securable object hierarchy 250 according to embodiments of the invention. In some embodiments, the securable object hierarchy includes containment objects 252, securable objects 254, and fields 256. Containment objects 252 are objects that define aspects of an application or module that uses securable objects 254. An example of an application may be a human resources application that includes several modules, including a time card module that manages time and accounting for employees, and an employee detail module that manages data regarding employees such as name, address, taxpayer identification, pay rate, dependents etc. Further, a supplier management application may include modules that manage purchase orders and modules that manage inventory. A securable object 254 is an object within a business class. A field 256 comprises a data field within a securable object 254. Each of containment objects 252, 254, and 256 may include security classes that define access to the objects and fields.

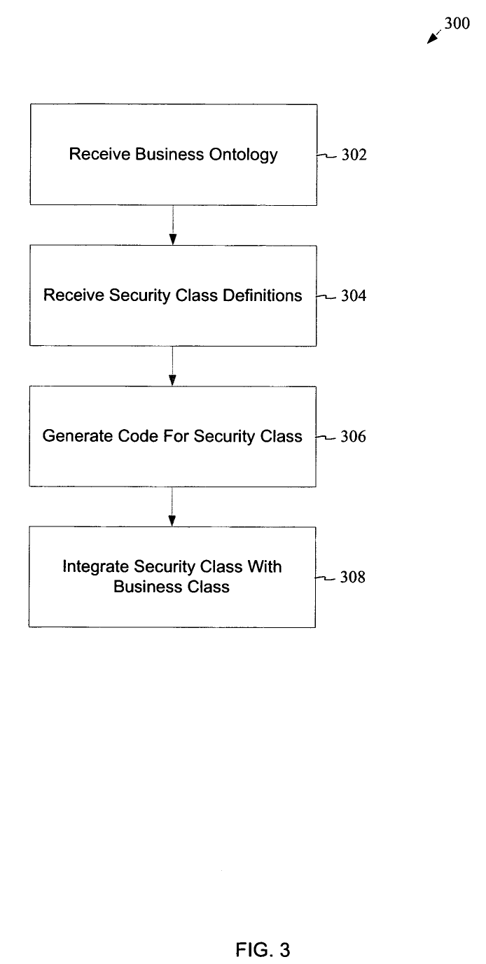

FIGS. 3, 4 and 5 illustrate flow diagrams of methods for generating a security interface from grammar elements in a pattern language and methods for evaluating security according to the grammar elements. The methods to be performed by the operating environment constitute computer programs made up of computer-executable instructions. Describing the methods by reference to a flowchart enables one skilled in the art to develop such programs including such instructions to carry out the methods on suitable computers (the processor or processors of the computer executing the instructions from computer-readable media such as ROMs, RAMs, hard drives, CD-ROM, DVD-ROM, flash memory etc. The methods illustrated in FIG. 3, 4 and 5 are inclusive of acts that may be taken by an operating environment executing an example embodiment of the invention.

FIG. 3 is a flowchart illustrating an exemplary method for generating a security interface according to embodiments of the invention. In some embodiments, the method begins at block 302 by receiving a business ontology. As noted above, the business ontology may be specified by a pattern language that provides grammar elements enabling an application designer to define business classes, fields within a business class, relationships between business classes, and business rules regarding the business classes and fields. The pattern language may be read from files, a repository, or a database. Example business class definition are provided below in FIGS. 8A and 8B.

At block 304, the system receives definitions for one or more security classes. As described above, the security classes comprise a security pattern language that an application designer may use to define the conditions under which a user may access one or more business objects in a business ontology.

At block 306, the system generates code that implements the security rules and conditions defined by the security pattern language. In some embodiments, a parser parses the security pattern language, checking the syntax and business class references in the security pattern language. A code generator then reads the parsed security pattern language objects and generates software code that implements the rules and conditions defined within the rules. In some embodiments, the generated code queries a database for roles assigned to a current user. The privileges associated with packages assigned to the roles are passed to a generated security evaluation method. A BNF defining the syntax of a security pattern language according to some embodiments is provided below in Appendix B. In some embodiments, Java code is generated.

At block 308, the security class code generated at block 306 is integrated with the business class code that implements the business ontology and associated objects. In some embodiments, the security class code is integrated within the business class code by inserting a call to the security evaluation method wherever code implementing an action (e.g. create, inquire, update or delete) is generated.

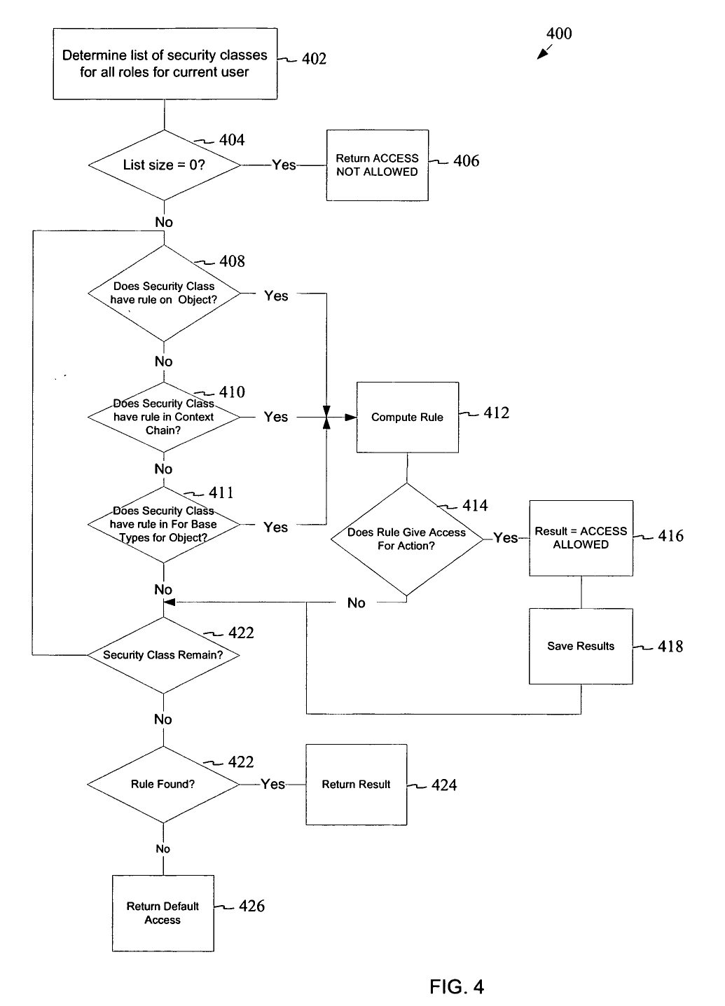

FIG. 4 is a flowchart illustrating a method 400 for evaluating security authorization according to embodiments of the invention. In some embodiments, the method illustrated in FIG. 4 evaluates access for a current action on an object for the current user. Typically the method is invoked when an action (e.g. create, inquire, update or delete) is about to be performed for an object. The object is typed based on its position in the set of objects that make up the information for the current user request. As noted above, in some embodiments, the object type may indicate that the object is a container object, a business object, or a content (i.e. field) object. The method begins at block 402 by determining a list of all applicable security classes for all of the roles assigned to the user. A check is made at block 404 to see if at least one security class is in the list. If no security classes were applicable based on the roles of the user, then at block 406 the method ends by returning an indication that no access is allowed for the user.

Otherwise, at least one security class exists and has been placed in the list of security classes applicable based on the roles for the user. Block 408 is the top of a loop that evaluates each of the security classes in the list. At block 408, the system checks to see if the current security class provides a rule for the current object. If the current security class does provide a rule, the system proceeds to block 412 to compute (e.g. evaluate) the rule.

If the current security class does not provide a rule for the current object, then at block 410 the system checks to see if the current security class provides a rule based on its key fields. For example, an employee object may have an employee identification number as a key field. Other objects having the same key field may be time card objects for the employee, performance review data for the employee, or employment history data for the employee. Thus a rule applying to an object having a key field may be applied to other objects sharing the key field (i.e. the context chain). If a rule for the key field for the current object is not found, rules on the key fields in the ontological context chain are looked up. Using the key field definitions provided in FIG. 9A as an example, if there is a rule on the HRCompany key field that gives the user access, then a user will have access to the Employee object since the Employee business object has HRCompany in its ontological context chain. This context lookup can be recursive until the top of the ontological context chain is reached. This is a very powerful way of giving access to ontologically related data. For example, if a user has the security class “AllHRCorpAccess.secclass” illustrated in FIG. 10D, the user will have access to all data related to HR company having the value 100. This will include all employees whose HR company key field value is 100. If the current security class provides a rule for an object in the context chain, then the system proceeds to block 412 to compute the rule.

If the security class does not provide a rule for the ontological context chain or the current object, the system at block 411 checks to see if the security class provides a rule for a base type for the object. A base type comprises an object type that is inherited by the current object. For example, a corporate officer object may inherit definitions from a corporate manager object definition, which in turn may inherit definitions from an employee object definition. Thus if the current object is a corporate officer object, then rules applying to manager objects or employee objects (i.e. base types for the corporate office object) may apply and be evaluated. If the security class provides a rule for such a base type, then the system proceeds to block 412 to compute the rule.

After the rule is evaluated at block 412, the system determines at block 414 if the rule allows access for the desired action. For example, a rule may allow inquiry actions for the current user, but not allow creates, updates, or deletions. If the rule allows access for the action, then at block 416 the result of the evaluation is set to allow the desired access. In addition, in some embodiments, the result is saved at block 418 for later use.

At block 422, the system checks to determine if any security classes remain in the list to be evaluated. If a security class remains, the system returns to block 408 to evaluate the next security class in the list. Otherwise, if no security classes remain, the system proceeds to block 422 to check to determine if any of the security classes in the list provided a rule allowing access for the desired action. If a rule was found, then at block 424 the system returns the resulting rule allowing access. Otherwise, in some embodiments, the system proceeds to block 426 to return a default access. In some embodiments, the default is to provide no access to the object.

It should be noted that multiple security classes may apply to an object, and that therefore multiple types of access may be provided by the rules in the security classes. In some embodiments, the system applies the least restrictive rule. However, in alternative embodiments, the most restrictive rule may be applied.

It should also be noted that rule interpretation may be different for different object types. For example, in some embodiments, a “pessimistic” security view is applied for containment objects and business objects. In these embodiments, the system applies the most restrictive rule that is found, and the default is to deny access if no rule is found. For content objects (i.e. field objects), an “optimistic” security view may be applied. For these objects, the least restrictive rule that is found is used, and the default is to allow access if no rule is found.

The following pseudocode provides a further description of the method illustrated in FIG. 4.

```
SET userSecClasses to list of security classes collected from all roles for
    USER
IF size of userSecClasses is zero
      RETURN NO_ACCESS
END IF
SET secClassesResults array to an array of boolean of size same as size
    of userSecClasses
SET result to NO_ACCESS
SET rule to null
FOR each securityclass in userSecClasses
    IF securityclass has a rule on the OBJECT
        SET rule to rule found
    ELSE IF securityclass has a rule on Key Fields in its ontological
          context chain
        SET rule to rule found
    ELSE IF securityclass has a rule for any base types for OBJECT
        SET rule to rule found
    END IF // find rule
    IF rule was found
        COMPUTE rule
        IF rule gives access for that ACTION
            SET result to ACCESS_ALLOWED
            SET element in secClassesResults array for this
            securityclass to value true
        END IF // securityclass has a rule on the OBJECT
    END IF // rule was found
    IF rule was found AND result is ACCESS_ALLOWED
        IF OBJECT is of type CONTENT OBJECT
            BREAK
    END IF
    END IF
END FOR // each userSecClasses
IF OBJECT is not of type CONTENT OBJECT
    SAVE secClassesResults
END IF
IF rule was not found
    SET result to default access for type
END IF
RETURN result
```

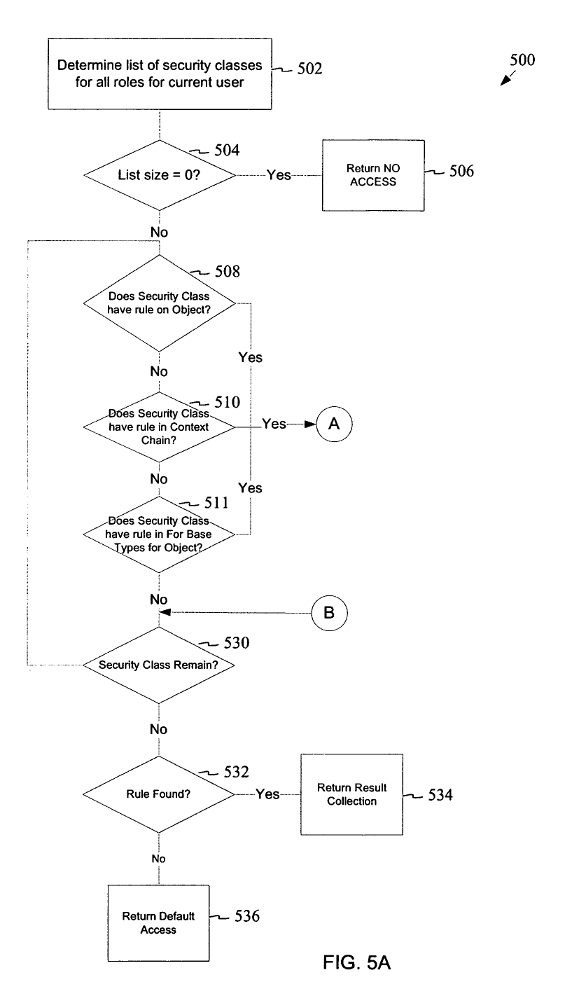

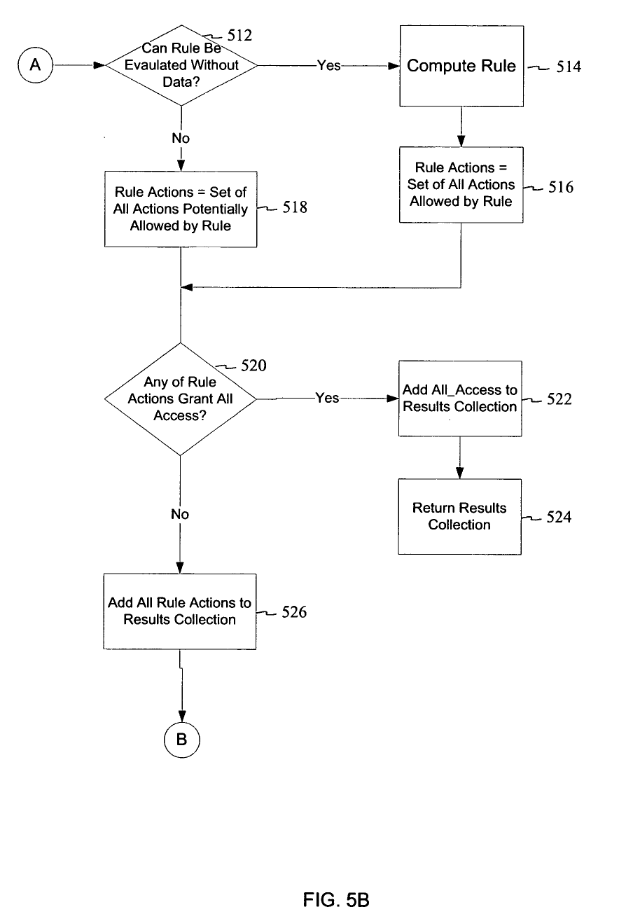

FIGS. 5A and 5B are flowcharts illustrating a method 500 for predicting security evaluation results according to embodiments of the invention. In general, the method accumulates all of the actions allowed on a current object for the current user. As noted above, the object may be a container object, a business object, or a content object (i.e. a field within a business object). The method begins at block 502 by determining a list of all applicable security classes for all of the roles assigned to the user. A check is made at block 504 to see if at least one security class is in the list. If no security classes were applicable based on the roles of the user, then at block 506 the method ends by returning an indication that no access to the current object is allowed for the user.

Otherwise, at least one security class exists and has been placed in the list of security classes applicable based on the roles for the user. Block 508 is the top of a loop that evaluates each of the security classes in the list. At block 508, the system checks to see if the current security class provides a rule for the current object. If the current security class does provide a rule, the system proceeds to block 512 (through connector A on FIG. 5A to connector A on FIG. 5B) to attempt to compute (e.g. evaluate) the rule and predict the access allowed for the rule. If the current security class does not provide a rule for the current object, then at block 510 the system checks to see if the current security class provides a rule based on the context chain. As discussed above, the context chain comprises a set of one or more objects that either directly or indirectly refer to the current object through a shared key. If the current security class provides a rule for an object in the context chain, then the system proceeds to block 512 (through connector A on FIG. 5A to connector A on FIG. 5B) to attempt to compute (e.g. evaluate) the rule and predict the access allowed for the rule.

If the security class does not provide a rule for the ontological context chain or the current object, the system at block 511 checks to see if the security class provides a rule for a base type for the object. A base type comprises an object type that is inherited by the current object. If the security class provides a rule for such a base type, then the system proceeds to block 512 (through connector A on FIG. 5A to connector A on FIG. 5B) to attempt to compute (e.g. evaluate) the rule and predict the access allowed for the rule.

FIG. 5B illustrates a method for predicting access provided by rules in a security class according to embodiments of the invention. At block 512, the system checks to determine if the rule can be evaluated without reference to data for the current object type. If so, the system proceeds to block 514 to compute (i.e. evaluate) the rule. After the rule is evaluated at block 514, then at block 516 the system adds all of the actions allowed by the rule to a results set. For example, a rule may allow inquiry and update actions for the current user, but not allow creates, or deletions.

If the check at block 512 determines that object data is required to evaluate the rule, then at block 518 the system proceeds to analyze the rule to determine a set of all actions that could potentially be allowed by the rule and adds the potentially allowable rules to the results set.

At block 520, the system checks to see if any of the rules grant access to all actions. If so, the system proceeds to block 522 to add an all access indicator to the results collection. The system then returns the results to a caller of the method at block 524. This essentially cuts off any further evaluation on the assumption that further evaluation is not required if access to all actions is granted by a rule. This is desirable because it makes prediction more efficient.

Otherwise, if a rule does not grant access to all actions, at block 526 the system adds the set of potentially allowable actions to the results collection.

Referring back to FIG. 5A, the system then proceeds to block 530 (via connector B) to determine if any security classes remain to be evaluated. If so, the system returns to block 508 to evaluate the next security class.

Otherwise, no security classes remain to be evaluated. At block 532, the system checks to see if any rules were found during the evaluations of the applicable security classes. If a rule was found, the results collection determined by the rule or rules is returned at block 534. Otherwise, if no rule was found, a default access may be returned at block 536. As discussed above, in some embodiments the default is to allow access for content or field objects, and to deny access for containment or business objects.

The following is a pseudocode description of the method illustrated in FIGS. 5A and 5B.

```
// The following pseudocode is used to predict authorization results for any
// object at any granularity. The pseudocode accumulates all actions
// allowed on the current OBJECT for the current USER. The object is
// typed based on its position in the set of objects that make up the
// information for the current USER request. Types are CONTAINER,
// BUSINESS OBJECT or CONTENT OBJECT.
SET userSecClasses to list of security classes collected from all roles for
  USER
Set resultCollection to new Collection
IF size of userSecClasses is zero
    ADD NO_ACCESS to resultCollection
    RETURN resultCollection
END IF
SET result to NO_ACCESS
SET rule to null
SET ruleActions to null
FOR each securityclass in userSecClasses
    IF securityclass has a rule on the OBJECT
        SET rule to rule found
    ELSE IF securityclass has a rule on Key Fields in its ontological
          context chain
        SET rule to rule found
    ELSE IF securityclass has a rule for any base types for OBJECT
        SET rule to rule found
    END IF // find rule
    IF rule was found
        IF rule can be evaluated without data
            COMPUTE rule
            SET ruleActions to a collection of all actions allowed
                by the rule
        ELSE
            SET ruleActions to a collection of all actions that can
                potentially be granted from the rule
        END IF
        IF rulesActions contains ALL_ACCESS
            ADD ALL_ACCESS to resultCollection
            RETURN resultCollection
        END IF
    END IF // rule was found
    IF rule was found
        ADD all actions from ruleActions to resultCollection
    END IF
END FOR // each userSecClasses
IF rule was not found
    ADD default access for type to resultCollection
    RETURN resultCollection
END IF
RETURN result
```

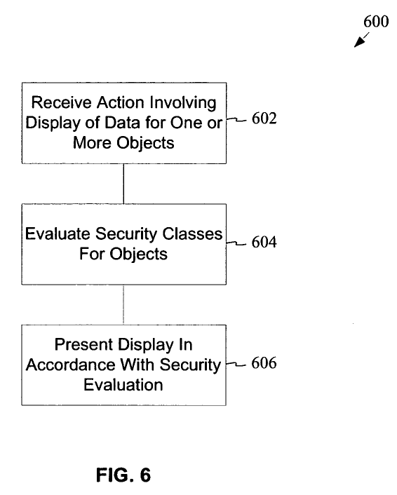

FIG. 6 is a flowchart illustrating a method 600 for displaying object data in accordance with a security evaluation according to embodiments of the invention. The method begins at block 602 by receiving an action that involves the display of object data for a business object. For example, an inquire action may involve the display of data for an existing object. An update action may display current data for an object that is to be updated.

At block 604, the system evaluates the security classes associated with the objects or objects. In some embodiments, the security evaluation returns a bitmap indicating which fields in the object have security rules associated with them.

At block 606, the system presents a display in accordance with the security class evaluations. The display may be different according to the object security that was applied. For example, if the security evaluation determines that access to the current object is not allowed, then a warning may be displayed indicated that the current user may not access the object. Similarly, if access is allowed to an object, but the current user is not allowed to create or update the object, then a warning may be displayed.

In some embodiments, the security evaluations may affect the display of content objects on a display. For example, an inquiry may be made where access is allowed for some of the content objects, but not allowed for other objects. In some embodiments, the data for object where access is not allowed may be blank. In alternative embodiments, the data may be replaced with a filler character, such as an asterisk or question mark. In further alternative embodiments, the data and associated label may not be displayed.

Additionally, the security evaluation may result in the ability to perform inquire actions for content objects, but not allow updates. In some embodiments, the system indicates which fields are available for editing. For example, data that may be updated may be displayed in a normal shade or color, whereas data that may not be updated may be displayed in an alternative shade or color indicating the field data may not be updated. Other form of highlighting the data, the label associated with the data, or a boundary graphics surrounding the data may be used to indicate that the security evaluation indicates the data may not be updated.

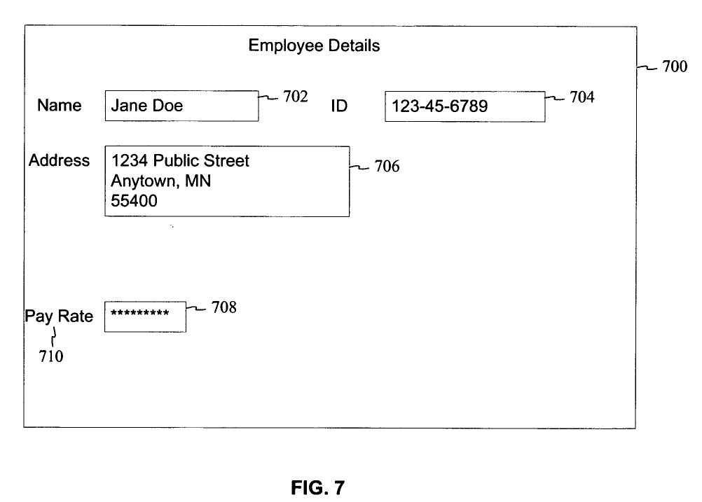

FIG. 7 is an example screen display 700 according to the method illustrated in FIG. 6. The example screen display 700 presents employee details, and includes a name field 702, an employee ID field 704, an address field 706, and a pay rate field 708. In the example shown, name field 702 and ID field 704 are presented in a lighter shade of gray, indicating that the security evaluation resulted in inquire actions allowed for the content objects having the name and ID, but that update actions are not allowed. Address field 706 is displayed using normal text attributes, indicating that inquire actions and update actions are allowed. The data for pay rate field 708 has been replaced with filler characters (asterisks) indicating that the current user may not perform inquire actions related to pay rate content. In alternative embodiments, pay rate field 708 may be blank. In further alternative embodiments, the pay rate field 708, and the pay rate field label 710 may be omitted from the display if inquiry actions are not allowed for the content objects having pay rate data.

FIG. 8A is an example pattern language segment illustrating an example definition of an employee business class. The example business class defines data and rules for an employee business class. The employee business class is contained within an “hcm” module. Various fields are defined, including a name fields, address fields, a manager field, a social security number field, an email address field, a department field and a pay rate field. Data in these fields may be used as part of a security class rule definition.

The example employee business class definition also includes condition definitions that indicate when an employee is considered a manager, and when an employee is managed by another employee. These conditions may be used in defining security class rules.

Additionally, the example employee business class defines a relationship “ManagedEmployees” where the set of employees managed by a particular manager are related.

FIG. 8B provides an example pattern language segment illustrating an example definition of a company (“HRCompany”) business class. The example business class defines data and rules for a company business class. Like the employee business class, the example company business class is contained within an “hcm” module. Fields are defined that provide the company name, the company address, the payroll year for the company, fields related to employee identification numbering and other fields. Further, rules are provided indicating that the company name field and the company address field are required fields, that is, a value is required for these fields in order for the record to be valid.

FIGS. 9A and 9B are example pattern language segments illustrating key field definitions for the business classes illustrated in FIGS. 8A and 8B. The key field pattern language segment illustrated in FIG. 9A indicates that employee is a key field for the employee business class and that the context is “HRCompany” The key field pattern language segment illustrated in FIG. 9B indicates that HRCompany is a key field for the HRCompany business class.

FIGS. 10A-10D are example security pattern language segments illustrating example definitions of security classes associated with the example business class illustrated in FIG. 8. FIG. 10A defines a “EmployeeSelfServiceAccess” security class providing security rules defining when an employee can access elements of the employee business class. In the example provided in FIG. 10A, unconditional access for inquire and change (i.e. update) actions is provided for the “hcm” module (a containment object). Additionally, the “Employee” business class is also accessible for inquire actions and update actions under the condition that the employee is the actor (i.e. user) making the inquiry or change. Further, the PayRate field, the Department field, and the HRManager field are accessible for inquire actions upon the condition that the employee is the actor (i.e. user) making the inquiry.

FIG. 10B is a security class defining access rights for a human resources administrator. The security class provides unconditional access for all actions in the “hcm” module, and for all business classes. In those embodiments where an “optimistic” security view for content objects is used, rules of individual content objects need not be defined on the assumption that for content objects, access for all actions is provided unless a rule specifies access for particular actions.

FIG. 10C is an example security class defining access rules for a manager. The example security class provides full access for all actions for the “hcm” module. In addition, a manager may perform inquire and update (i.e. change) actions upon the condition that the user is a manager of the employee represented by the business object.

FIG. 10D is an example security class defining access rules related to objects having an ontological context of “HRCompany.” The example pattern language segment provided in FIG. 10D provides access for all actions to any objects in the HRCompany ontological context when the company identification value is 100. The security class applies to any object in the HRCompany ontological context, regardless of its class type. For example, the employee class as defined in FIG. 8A is in the ontological context of HRCompany, thus the access rules define in the example provide in FIG. 10D apply to the employee class.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus the following claims are hereby incorporated into the Detailed Description, with each claim standing on its own as a separate embodiment.

The foregoing descriptions of specific embodiments of the present invention have been presented for purposes of illustration and description. The embodiments presented are not intended to be exhaustive or to limit the invention to the particular forms disclosed. It should be understood that one of ordinary skill in the art can recognize that the teachings of the detailed description allow for a variety of modifications and variations that are not disclosed herein but are nevertheless within the scope of the present invention. Accordingly, it is intended that the scope of the present invention be defined by the appended claims and their equivalents, rather than by the description of the embodiments.

What is claimed is:

1. A method comprising:
receiving a description of one or more business objects;
receiving a description of one or more ontological contexts for the one or more business objects, the description including relationship identifiers within the one or more ontological contexts;
receiving a description of security access rules based on the relationship identifiers; and
generating code according to the description of the one or more business objects, the description of the one or more ontological contexts, and the security access rules.

2. The method of claim 1, further comprising evaluating security access based on traversing an ontological context chain of business objects.

3. The method of claim 1, wherein the relationship identifiers comprise key fields and wherein the business objects include the key fields.

4. A method comprising:
receiving a description of a business ontology, the business ontology including business objects having fields;
receiving a pattern language segment providing security access rules for one or more of the business objects; and
generating code to implement the security access rules.

5. The method of claim 4, wherein generating code includes generating Java code.

6. The method of claim 5, wherein generating code includes inserting a call to the code implementing the security access rules into code generated for maintaining the one or more business objects.

7. The method of claim 6, wherein inserting the call includes inserting the call into code generated for performing an action on the one or more business objects.

8. The method of claim 4, wherein the business objects include containment objects, business objects or content objects.

9. A method for evaluating security for an object, the method comprising:
receiving an action related to the object;
receiving a set of one or more security classes associated with the object; and
determining an access status according to rules in the set of one or more security classes.

10. The method of claim 9, wherein determining an access status includes determining an access status based on an ontological context chain defined for one or more key fields within the object.

11. A method for predicting security for an object, the method comprising:
receiving a set of one or more security classes associated with an object type;
accumulating in a result set a set of rules that allow access to an object having the object type; and
indicating whether access may be allowed to the object having the object type according to the result set.

12. The method of claim 11, wherein accumulating in the result set includes determining if a rule can be evaluated without data from the business object, and if the rule cannot be evaluated with data from the business object then including in the result set rules that potentially allow access to the business object.

13. The method of claim 11, wherein indicating whether access may be allowed includes determining an access status based on an ontological context chain defined for one or more key fields within the object.

14. A system comprising:
a parser operable to parse a pattern language, the pattern language including definitions of one or more business objects and security classes defining access rules for the one or more business objects.
a repository operable to store the parsed pattern language and the parsed security classes; and
a code generator operable to generate code according to the pattern language and the parsed security classes.

15. The system of claim 14 wherein the code generator generates Java code.

16. A computer-readable medium having computer executable instructions for performing a method, the method comprising:
receiving a description of one or more business objects;
receiving a description of one or more ontological contexts for the one or more business objects, the description including relationship identifiers within the one or more ontological contexts;
receiving a description of security access rules based on the relationship identifiers; and
generating code according to the description of the one or more business objects, the description of the one or more ontological contexts, and the security access rules.

17. The computer-readable medium of claim 16, wherein the method further comprises evaluating security access based on traversing an ontological context chain of business objects.

18. The computer-readable medium of claim 16, wherein the relationship identifiers comprise key fields and wherein the business objects include the key fields.
